(19) United States
(12) Patent Application Publication
(10) Pub. No.: US 2026/0154079 A1
(43) Pub. Date: Jun. 4, 2026

(54) METHOD AND DEVICE WITH PROFILE DATA GENERATION

(71) Applicant: Samsung Electronics Co., Ltd., Suwon-si (KR)

(72) Inventors: Jintaek KANG, Suwon-si (KR); Jae-Eon JO, Suwon-si (KR)

(73) Assignee: Samsung Electronics Co., Ltd., Suwon-si (KR)

(21) Appl. No.: 19/226,267

(22) Filed: Jun. 3, 2025

(30) Foreign Application Priority Data
Nov. 29, 2024 (KR) 10-2024-0174479

(51) Int. Cl. G06F 9/30; G06F 1/06; G06F 9/38

(52) U.S. Cl. CPC G06F 9/30079; G06F 1/06; G06F 9/30036; G06F 9/3844

(57) ABSTRACT

A method and device for obtaining profile data of a vector machine are provided. An electronic device includes a plurality of core components configured to operate based on a first clock and a level 1 (L1) data cache configured to operate based on a second clock, wherein the component may include a decoder configured to obtain a maximum number of data elements that are processable in parallel by a vector machine to be analyzed and insert one or more no operation (NOP) instruction between a first instruction and a second instruction of an instruction set processed by a core, based on the maximum number of data elements.

### CROSS-REFERENCE TO RELATED APPLICATIONS

This application claims the benefit under 35 USC § 119(a) of Korean Patent Application No. 10-2024-0174479, filed on Nov. 29, 2024, in the Korean Intellectual Property Office, the entire disclosure of which is incorporated herein by reference for all purposes.

### BACKGROUND

### 1. Field

The following description relates to a method and device with profile data generation.

### 2. Description of Related Art

A vector machine (e.g., a vector processor) is a system capable of processing multiple data elements (e.g., vectors) simultaneously, and may play an important role in applications that require large-scale data processing, such as artificial intelligence (AI).

To design the architecture of a vector machine, it is necessary to obtain profile data that reflects performance information of the corresponding vector machine. A software simulator is typically used for this purpose; however, such simulation may require considerable time to complete.

The above information may be presented as the related art to help with the understanding of the disclosure. No arguments or decisions are raised to whether any of the above description is applicable as the prior art related to the present disclosure.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes a plurality of core components configured to operate based on a first clock; and a level 1 (L1) data cache configured to operate based on a second clock, wherein the core component comprises: a decoder configured to: obtain a maximum number of data elements that are processable in parallel by a vector machine to be analyzed; and insert one or more no operation (NOP) instructions between a first instruction and a second instruction of an instruction set processed by a core, based on the maximum number of data elements; a register configured to store the maximum number of data elements received from the decoder; and a performance monitoring unit (PMU) configured to increase a counter value of a vector instruction corresponding to the instruction set, based on the maximum number of data elements stored in the register.

The instruction set may include instructions generated by compiling parallelizable program code using a scalar method.

In response to the first clock and the second clock being decoupled, a speed of the first clock may be faster than a speed of the second clock based on the maximum number of data elements.

The core component may further include a branch predictor configured to determine an instruction block to be accelerated from the instruction set and provide information about the determined instruction block to the PMU.

The information about the determined instruction block may be stored as a look up table (LUT).

The branch predictor may be further configured to initiate detection of the instruction block to be accelerated from based on the maximum number of data elements being stored in the register.

The branch predictor may be further configured to detect the instruction block to be accelerated based on two occurrences of a branch being taken to a same address.

The PMU may be further configured to provide, to the decoder, a list of instructions to be accelerated within the determined instruction block.

The decoder may be further configured to insert one or more NOP instructions between two instructions that may be not included in a list of instructions to be accelerated within the determined instruction block, and a number of NOP instructions inserted between the two instructions may be determined based on the maximum number of data elements.

In response to the second clock being coupled to the first clock, a speed of each of the first clock and the second clock may be increased based on the maximum number of data elements.

In response to the second clock being coupled to the first clock, the core component may further include a request buffer configured to store a request in response to an occurrence of an L1 cache miss and to delay sending the request to another memory layer based on the maximum number of data elements.

In one general aspect, a processor-implemented method includes obtaining a maximum number of data elements that is processable in parallel by a vector machine through a decoder of a core; writing the maximum number of data elements to a register through the decoder; increasing, through a performance monitoring unit (PMU) of the core, a counter value of a vector instruction corresponding to an instruction set processed by the core, based on the maximum number of data elements stored in the register; and inserting, through the decoder, one or more no operation (NOP) instructions between a first instruction and a second instruction of the instruction set, based on the maximum number of data elements.

The instruction set may include instructions generated by compiling parallelizable program code using a scalar method.

A first core clock speed of the core, at a first time point after the maximum number of data elements is stored in the register, may be faster by a value corresponding to the maximum number of data elements than a second core clock speed of the core at a second time point before the maximum number of data elements is stored in the register.

The method may further include determining, through a branch predictor of the core, an instruction block to be accelerated from the instruction set; and providing, through the branch predictor, information about the determined instruction block to the PMU.

The method may further include initiating detection of the instruction block to be accelerated based on the maximum number of data elements being stored in the register.

The determining of the instruction block to be accelerated may include detecting the instruction block based on two occurrences of a branch being taken to a same address, through the branch predictor.

The method may further include providing, through the PMU, a list of instructions to be accelerated within the determined instruction block to the decoder.

The inserting of the one or more NOP instructions may include inserting the one or more NOP instructions between two instructions that are not included in a list of instructions to be accelerated within the determined instruction block, through the decoder, and a number of NOP instructions inserted between the two instructions may be determined based on the maximum number of data elements.

The method may further include in response to a cache clock of a level 1 (L1) data cache being coupled to a core clock of the core, storing, by a request buffer, a request in response to an occurrence of an L1 cache miss; and delaying sending the request to another memory layer based on the maximum number of data elements.

Other features and aspects will be apparent from the following detailed description, the drawings, and the claims.

### BRIEF DESCRIPTION OF THE DRAWINGS

FIG. 1 illustrates an example single instruction, multiple data (SIMD), which is a representative computation technique used by a vector machine according to one or more embodiments.

FIG. 2 illustrates an example core that supports vector extension according to one or more embodiments.

FIG. 3 illustrates an example code compilation for parallelizable operations according to one or more embodiments.

FIGS. 4 and 5 illustrate an example electronic device according to one or more embodiments.

FIG. 6 illustrates an example method of inserting a no operation (NOP) instruction according to one or more embodiments.

FIG. 7 illustrates an example method of obtaining profile data of a vector machine according to one or more embodiments.

FIG. 8 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

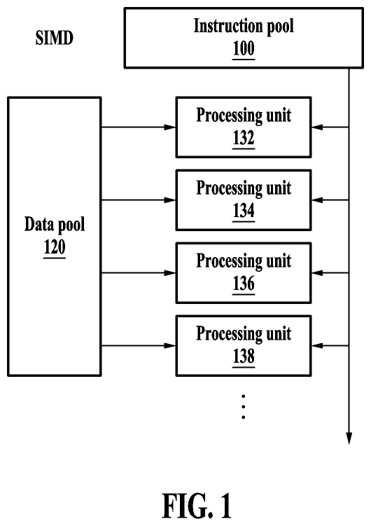

FIG. 1 illustrates an example single instruction, multiple data (SIMD), which is a representative computation technique used by a vector machine according to one or more embodiments.

Referring to FIG. 1, according to an example, a vector machine (e.g., a vector processor such as a graphics processing unit (GPU)) may process computations on multiple data elements (e.g., vectors) in parallel using SIMD techniques.

An instruction pool 100 may represent a component or memory region configured to store and manage instructions (e.g., vadd, vsub, and/or vmul). Instructions from the instruction pool 100 may be transmitted to a plurality of processors 132, 134, 136, and 138.

A data pool 120 may represent a region configured to store data elements for parallel processing. Each data element corresponding to a particular instruction may be transmitted to a respective processor for execution.

Each of the plurality of processors 132, 134, 136, and 138 may be a computation unit that performs a vector computation. Each processing unit may perform the vector computation using data from the data pool 120 and the instruction from the instruction pool 100. The processors 132, 134, 136, and 138 may be implemented within a core of the vector machine.

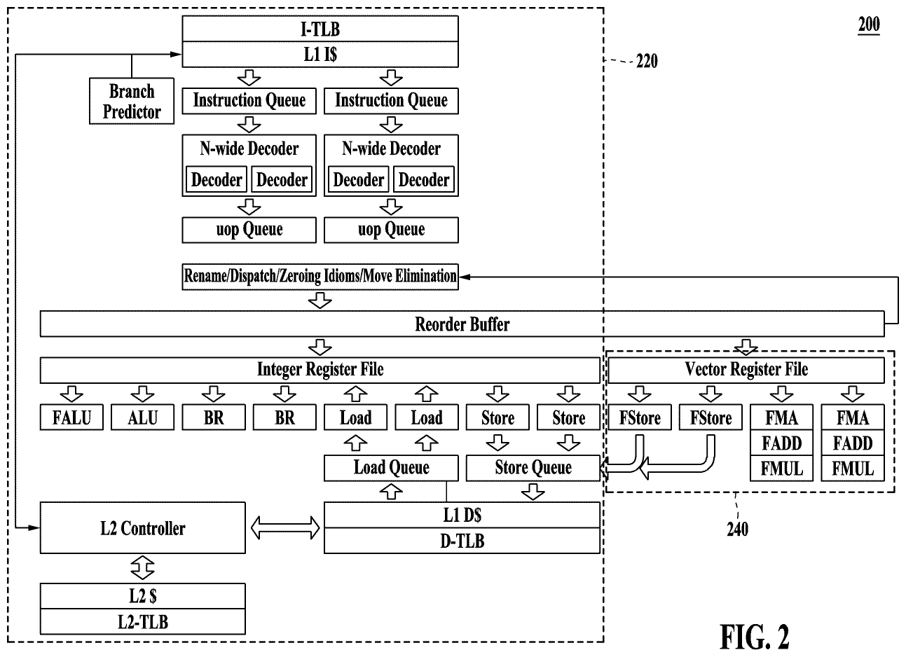

FIG. 2 illustrates an example architecture of a core configured to support vector extensions according to one or more embodiments.

Referring to FIG. 2, a core 200 for supporting vector extension may include two distinct core architectures (e.g., first and second core architectures 220 and 240), for illustrative purposes. The first core architecture 220 may be configured for scalar operation support, and the second core architecture 240 may be configured for vector extension support.

In applications (e.g., artificial intelligence, graphics processing, and/or signal processing) that require processing large amounts of data at high speed, it may be important to process data quickly using the second core architecture 240.

To develop next generation vector machines, it is beneficial to evaluate the performance of the second core architecture 240 in advance. Typically, a software simulator may be used to obtain profile data that may be used to confirm performance of a target vector machine. However, software-based simulation may suffer from drawbacks such as prolonged simulation times. Accordingly, the one or more embodiments may provide a method of obtaining the profile data of the target vector machine using a hardware-based solution. As used herein, the term “target vector machine” may refer to a vector machine that a user intends to analyze, and the term “profile data” may refer to data/information that characterizes the performance of the vector machine.

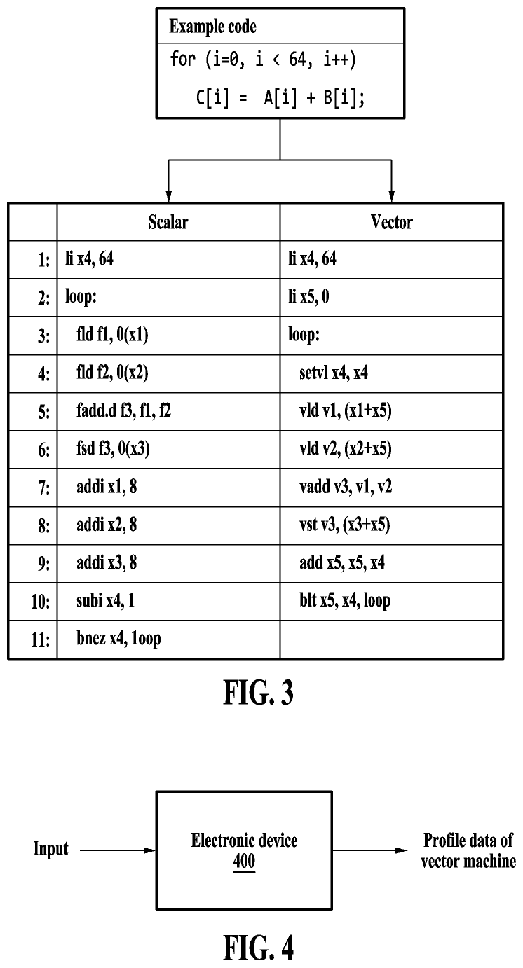

FIG. 3 illustrates an example code compilation for parallelizable operations according to one or more embodiments.

Referring to FIG. 3, example code may include a loop-based, element-wise addition operation. Such code may be parallelized through vectorization.

An instruction set generated by compiling the example code using a scalar compilation method is different from that generated via a vector compilation method. Accordingly, the processing time of when the example code is processed using a scalar machine may be different from the processing time of when the corresponding example code is processed using a vector machine, due to differences in the resulting instruction streams and hardware capabilities.

In one or more embodiments, profile data of a target vector machine may be obtained using a core that does not support vector extensions. This core may execute an instruction set (or code) generated by compiling parallelizable code using the scalar method, enabling estimation of vector performance characteristics based on scalar execution behavior.

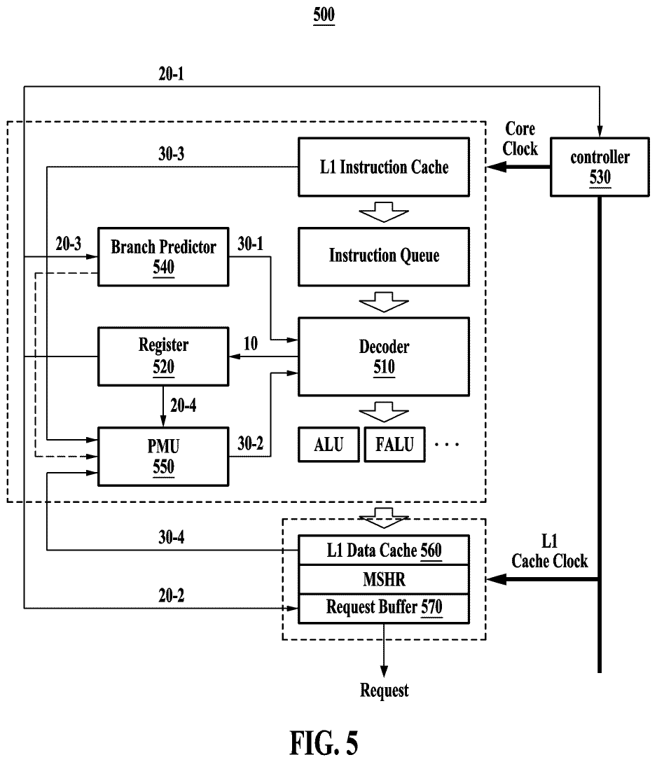

FIGS. 4 and 5 illustrate an example electronic device according to one or more embodiments. Hereinafter, emphasis is placed on the functions of core components proposed to support the generation of profile data of a vector machine based on a hardware device. A description of general functionalities of these core components is omitted for brevity.

Referring to FIG. 4, an electronic device 400 may be configured to generate and/or output profile data of a target vector machine based on user input. The profile data may include various pieces of data representing performance information/characteristics of the target vector machine. For example, the profile data may include the number of executions of a vector instruction (e.g., vadd, vload, and/or vmul) that corresponds to particular code (e.g., an instruction set in a “scalar” column of FIG. 3).

The user input may include the maximum number of elements (or the vector length) that may be processed in parallel by the target vector machine. For example, when the target vector machine is a 4-way vector machine, a user may input “4”, which is the maximum vector length that the corresponding target vector machine may process in parallel, to the electronic device 400.

The user input may also include, as necessary, parallelizable code (e.g., the code illustrated in FIG. 3) to be processed by the electronic device 400 for analysis of the target vector machine. When no code is not provided by the user, the electronic device 400 may retrieve and use code stored in a memory (e.g., a memory 840 of FIG. 8) of the electronic device 400.

The user input may include information about instructions to be accelerated (e.g., a list of instructions such as fld, fadd.d, and/or fsd as shown in FIG. 3).

Referring to FIG. 5, the electronic device 400 may generate the profile data of the target vector machine by executing the parallelizable code using components (e.g., hardware components or hardware architectures) of a core 500. Although FIG. 5 schematically illustrates a simplified structure of the core 500 for ease of description, the core 500 may further include additional components not shown. The description hereafter focuses only on those components necessary to convey the technical concept of the present disclosure.

The operations depicted in FIG. 5 are provided by way of example, the scope of the present disclosure is not limited by the order of operations shown in FIG. 5.

In operation 10, a decoder 510 may write (or record), to a register 520, a value representing the maximum number (or a vector length) “N” (e.g., a natural number other than 1) of data elements to be processed in parallel by the target vector machine. The decoder 510 may obtain the vector length “N” from user input. The register 520 may be implemented as a k-bit register, where k is a natural number.

In operation 20-1, a controller 530 may increase the speed of a core clock (e.g., the core clock frequency) in accordance with the vector length “N”, based on the vector length “N” being stored in the register 520. For example, the controller 530 may increase the speed of the core clock by a factor of “N” relative to the speed before the vector length “N” is stored in the register 520.

In operation 20-2, when the core clock and a level 1 (L1) cache clock cannot be decoupled from each other, the controller 530 may increase each of the speed of the core clock and the speed of the L1 cache clock to correspond to “N”. For example, the controller 530 may increase both the speeds of the core clock and the L1 cache clock by a factor of “N”. Since the speed of the core clock needs to be faster than the speed of the L1 cache clock to accurately simulate an operation of the target vector machine, when the L1 cache clock is not able to be decoupled from the core clock, a means to solve the clock decoupling issue may be necessary. The core 500 may solve the decoupling issue using delay logic included in a request buffer 570. The request buffer 570 may store a request (e.g., a memory access request) according to the occurrence of an “L1 cache miss” and may delay transmission of the request to another memory layer (e.g., a higher memory layer such as an L2 cache). For example, the request buffer 570 may transmit the request to another memory layer in response to the time of a clock cycle (e.g., “N” clock cycles) corresponding to the vector length “N” elapsing.

In operation 20-3, a branch predictor 540 may initiate detection of an acceleration target instruction block (e.g., an instruction block of rows 3 to 11 in the “scalar” column of FIG. 3) from an instruction set (e.g., an instruction set of the “scalar” column of FIG. 3) corresponding to the parallelizable code (e.g., the example code of FIG. 3). The detection may be based on the vector length “N” stored in the register 520. The acceleration target instruction block may refer to a group of consecutive instructions that may increase execution speed based on vector extension. The branch predictor 540 may detect the acceleration target instruction block from the instruction set based on the occurrence of a branch outcome such as “branch taken” or “branch not taken”. For example, when two consecutive “branch taken” events occur at the same address, the branch predictor 540 may determine an instruction block corresponding to the corresponding address as the acceleration target instruction block. The branch predictor 540 may provide information about the acceleration target instruction block to a performance monitoring unit (PMU) 550. The branch predictor 540 may detect an instruction that may be executed by the target vector machine among instructions included in the acceleration target instruction block.

In operation 20-4, the PMU 550 may start managing/tracking a counter of instructions (e.g., vector instructions such as vload, vstore, and/or vadd) based on the vector length “N” stored in the register 520. For example, when fload, fstore, and/or fadd is executed by the number of times corresponding to the vector length “N”, the PMU 550 may increase a counter value of the vector instructions (e.g., vload, vstore, and/or vadd) corresponding to fload, fstore, and/or fadd by 1. For example, when the vector length “N” is 8, the PMU 550 may increase the counter value of vload by 1 whenever fload is executed by eight times.

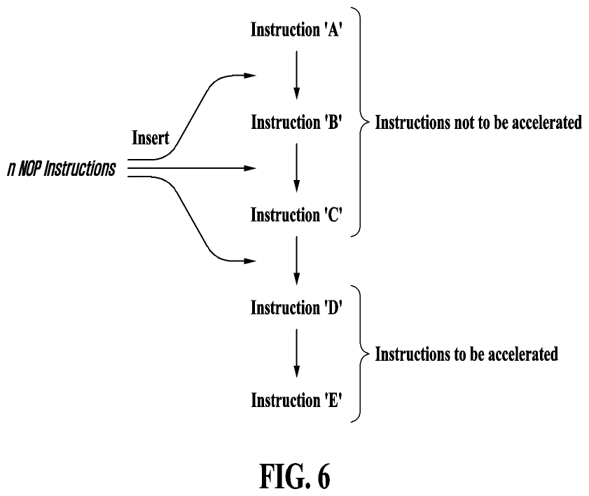

In operation 30-1, the branch predictor 540 may transmit a signal (e.g., a trigger signal) to the decoder 510 upon the detection of the acceleration target instruction block. The decoder 510 may enter a mode for simulating vector extension, in response to receiving the corresponding signal from the branch predictor 540. To simulate the vector extension, the decoder 510 may insert at least one no operation (NOP) instruction based on at least one of a location of an instruction to be accelerated or a location of an instruction not to be accelerated, into the instruction set (e.g., the instruction set of the “scalar” column of FIG. 3). For example, the decoder 510 may insert at least one NOP instruction between two instructions that are not to be accelerated. The instruction to be accelerated may represent an instruction (e.g., fld, fadd.d, and/or fsd of FIG. 3) that may be accelerated through the vector extension within an instruction set (e.g., the instruction set in the “scalar” column of FIG. 3) generated by compiling the parallelizable code in a scalar method. The insertion of the NOP instruction by the decoder 510 is described in detail with reference to FIG. 6.

The decoder 510 may obtain information about the instructions to be accelerated in various methods. For example, the decoder 510 may obtain such information via user input. For example, the decoder 510 may receive such information from the PMU 550. For example, the decoder 510 may obtain such information from a lookup table (LUT) stored in a memory (e.g., the memory 840 of FIG. 8).

By increasing the speed of the core clock by a factor of “N” and inserting at least one NOP instruction into the instruction set by the decoder 510, the core 500 may simulate execution such that the instruction to be accelerated may be executed “N” times as in a normal state of the core 500, while the instruction not to be accelerated may be executed by the same number of times as the normal state of the core 500 during the same period. The “normal state” may refer to a state when the core 500 operates in a general mode (e.g., a mode for a scalar operation), without vector extension simulation.

In operation 30-2, the decoder 510 may receive information (e.g., a list of instructions) to be accelerated within the instruction set (e.g., the instruction set in the “scalar” column of FIG. 3) from the PMU 550. When the decoder 510 obtains such information from the PMU 550, the decoder 510 may automatically support the instruction to be accelerated, eliminating the need for user-provided instruction information.

In operation 30-3, the PMU 550 may manage the counter from an L1 instruction cache. In operation 30-4, the PMU 550 may manage the counter from an L1 data cache 560. Based on the vector length “N,” the PMU 550 may increase a value (e.g., the number of executions of vector instructions such as vadd, vload, and/or vstore) of a counter register that records performance statistics related to vector extension. The PMU 550 may increase a value of a counter register other than the counter register that records performance statistics related to vector extension using typical methods, regardless of an “N” value. For example, the PMU 550 may increase, by 1, a value of a counter register for each execution of a standard instruction such as add.

FIG. 6 illustrates an example method of inserting an NOP instruction according to one or more embodiments. Although FIG. 6 is provided for illustrating the technical concept of simulating vector extension through NOP instruction insertion, the scope of the one or more embodiments is not limited thereto.

Referring to FIG. 6, a decoder (e.g., the decoder 510 of FIG. 5) may insert at least one NOP instruction into an instruction set (or an acceleration target instruction block) including instructions “A,” “B,” “C,” “D,” and “E.” By inserting the NOP instruction, an instruction to be accelerated may be executed by a multiple (e.g., “N” times) corresponding to the vector length “N” (e.g., the vector length “N” defined in operation 10 of FIG. 3) and more times than an instruction not to be accelerated, within a predetermined time period. For example, while the instruction not to be accelerated is executed by “a” times, the instruction to be accelerated may be executed by “N ×a” times during the predetermined period of time.

In one example, when the instructions “A,” “B,” and “C” are instructions not to be accelerated and the instructions “D” and “E” are instructions to be accelerated, the decoder may insert at least one NOP instruction between instructions “A” and “B,” between instructions “B” and “C,” and between instructions “C” and “D,” respectively. The number of NOP instructions inserted may be determined based on the vector length “N”. For example, “N−1” NOP instructions may be inserted. However, this is only an example and various modifications are also within the scope of the present disclosure. For example, the number of NOP instructions inserted between the instructions “A” and “B” may differ from the number of NOP instructions inserted between the instructions “B” and “C.”

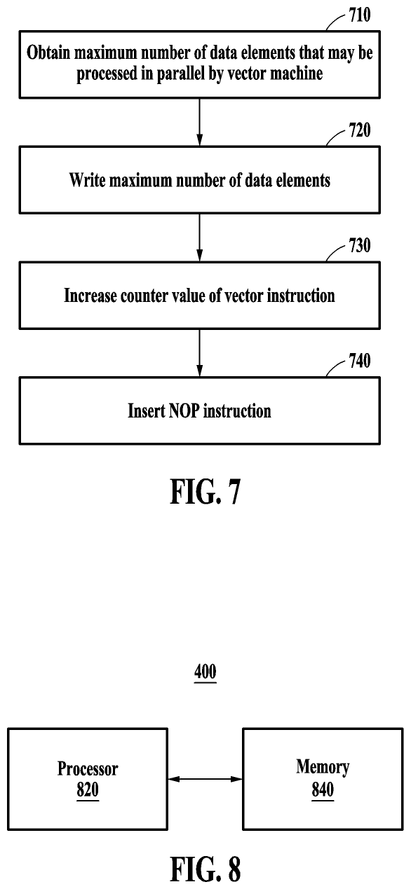

FIG. 7 illustrates an example method of obtaining profile data of a vector machine according to one or more embodiments.

Referring to FIG. 7, operations 710 through 740 may be performed sequentially but are not limited thereto. For example, two or more operations (e.g., operations 730 and 740) may be performed in parallel. In another example, the operations may be performed in a different order than that shown in FIG. 7. Operations 710 through 740 may correspond to or be functionally similar to the operations of the core components described with reference to FIG. 5, and repetitive descriptions are omitted.

In operation 710, a decoder (e.g., the decoder 510 of FIG. 5) may obtain the maximum number (e.g., the vector length “N” of FIG. 3) of data elements that may be processed in parallel by a vector machine (e.g., a target vector machine) that is a target for analysis.

In operation 720, the decoder may write the obtained maximum number of data elements to a register (e.g., the register 520 of FIG. 5).

In operation 730, a PMU (e.g., the PMU 550 of FIG. 5) may increase a counter value of a vector instruction corresponding to an instruction set (e.g., the “scalar” column of FIG. 3) processed by a core (e.g., the core 500 of FIG. 5), based on the maximum number of data elements stored in the register. Operation 730 may be performed in parallel with execution of a corresponding instruction.

In operation 740, the decoder may insert at least one NOP instruction between a first instruction and a second instruction of the instruction set (e.g., the instruction set processed in operation 730) based on the maximum number of data elements (i.e., the stored vector length).

FIG. 8 illustrates an example electronic device according to one or more embodiments.

Referring to FIG. 8, the electronic device 400 may include one or more processors 820 and a memory 840.

The memory 840 may store code/instructions (or programs) executable by the one or more processors 820. For example, the instructions may control operations of the one or more processors 820 and/or functions of individual components of the one or more processors 820.

The memory 840 may include one or more computer-readable storage media. The memory 840 may include non-volatile storage elements, such as a magnetic hard disk, optical disc, floppy disk, flash memory, electrically programmable memory (EPROM), and/or electrically erasable and programmable memory (EEPROM).

The memory 840 may be a non-transitory storage medium. The term “non-transitory” may refer to physical storage media and excludes transitory propagating signals or carrier waves. However, the term “non-transitory” should not be interpreted to mean that the memory 840 is non-movable.

The one or more processors 820 may process data stored in the memory 840. The one or more processors 820 may execute computer-readable code (e.g., software) stored in the memory 840 and instructions triggered by the one or more processors 820.

The one or more processors 820 may be a hardware-implemented data processing device including circuitry physically structured to execute desired operations, such as executing code or instructions in a program.

Examples of the hardware-implemented data processing device may include, but are not limited to, a microprocessor, a central processing unit (CPU), a processor core, a multi-core processor, a multiprocessor, an application-specific integrated circuit (ASIC), and a field-programmable gate array (FPGA).

The one or more processors 820 may include a main processor (e.g., a CPU or an application processor) and an auxiliary processor (e.g., a communication processor, a neural processing unit (NPU), and/or a GPU).

By executing the code, instructions, or applications stored in the memory 840, the one or more processors 820 may cause the electronic device 400 to perform one or more operations individually or collectively.

The electronic devices, processing units, processors, memories, storage devices, models, interfaces, controllers, branch predictors, decoders, buffers, registers, caches, processor 132/134/136/138, core 200, architecture 220/240, electronic device 400, and other apparatuses, devices, models, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An electronic device comprising:
a plurality of core components configured to operate based on a first clock; and
a level 1 (L1) data cache configured to operate based on a second clock,
wherein the core component comprises:
a decoder configured to:
obtain a maximum number of data elements that are processable in parallel by a vector machine to be analyzed; and
insert one or more no operation (NOP) instructions between a first instruction and a second instruction of an instruction set processed by a core, based on the maximum number of data elements;
a register configured to store the maximum number of data elements received from the decoder; and
a performance monitoring unit (PMU) configured to increase a counter value of a vector instruction corresponding to the instruction set, based on the maximum number of data elements stored in the register.

2. The electronic device of claim 1, wherein
the instruction set comprises instructions generated by compiling parallelizable program code using a scalar method.

3. The electronic device of claim 1, wherein,
in response to the first clock and the second clock being decoupled, a speed of the first clock is faster than a speed of the second clock based on the maximum number of data elements.

4. The electronic device of claim 1, wherein
the core component further comprises a branch predictor configured to determine an instruction block to be accelerated from the instruction set and provide information about the determined instruction block to the PMU.

5. The electronic device of claim 4, wherein
the information about the determined instruction block is stored as a look up table (LUT).

6. The electronic device of claim 4, wherein
the branch predictor is further configured to initiate detection of the instruction block to be accelerated from based on the maximum number of data elements being stored in the register.

7. The electronic device of claim 4, wherein
the branch predictor is further configured to detect the instruction block to be accelerated based on two occurrences of a branch being taken to a same address.

8. The electronic device of claim 4, wherein
the PMU is further configured to provide, to the decoder, a list of instructions to be accelerated within the determined instruction block.

9. The electronic device of claim 4, wherein
the decoder is further configured to insert one or more NOP instructions between two instructions that are not included in a list of instructions to be accelerated within the determined instruction block, and
a number of NOP instructions inserted between the two instructions is determined based on the maximum number of data elements.

10. The electronic device of claim 1, wherein,
in response to the second clock being coupled to the first clock,
a speed of each of the first clock and the second clock is increased based on the maximum number of data elements.

11. The electronic device of claim 1, wherein,
in response to the second clock being coupled to the first clock, the core component further comprises a request buffer configured to store a request in response to an occurrence of an L1 cache miss and to delay sending the request to another memory layer based on the maximum number of data elements.

12. A processor-implemented method, the method comprising:
obtaining a maximum number of data elements that is processable in parallel by a vector machine through a decoder of a core;
writing the maximum number of data elements to a register through the decoder;
increasing, through a performance monitoring unit (PMU) of the core, a counter value of a vector instruction corresponding to an instruction set processed by the core, based on the maximum number of data elements stored in the register; and
inserting, through the decoder, one or more no operation (NOP) instructions between a first instruction and a second instruction of the instruction set, based on the maximum number of data elements.

13. The method of claim 12, wherein
the instruction set comprises instructions generated by compiling parallelizable program code using a scalar method.

14. The method of claim 12, wherein
a first core clock speed of the core, at a first time point after the maximum number of data elements is stored in the register, is faster by a value corresponding to the maximum number of data elements than a second core clock speed of the core at a second time point before the maximum number of data elements is stored in the register.

15. The method of claim 12, further comprising:
determining, through a branch predictor of the core, an instruction block to be accelerated from the instruction set; and
providing, through the branch predictor, information about the determined instruction block to the PMU.

16. The method of claim 15, further comprising:
initiating detection of the instruction block to be accelerated based on the maximum number of data elements being stored in the register.

17. The method of claim 15, wherein
the determining of the instruction block to be accelerated comprises detecting the instruction block based on two occurrences of a branch being taken to a same address, through the branch predictor.

18. The method of claim 15, further comprising
providing, through the PMU, a list of instructions to be accelerated within the determined instruction block to the decoder.

19. The method of claim 15, wherein
the inserting of the one or more NOP instructions comprises inserting the one or more NOP instructions between two instructions that are not included in a list of instructions to be accelerated within the determined instruction block, through the decoder, and
a number of NOP instructions inserted between the two instructions is determined based on the maximum number of data elements.

20. The method of claim 12, further comprising:
in response to a cache clock of a level 1 (L1) data cache being coupled to a core clock of the core,
storing, by a request buffer, a request in response to an occurrence of an L1 cache miss; and
delaying sending the request to another memory layer based on the maximum number of data elements.
